(19) United States
(12) Patent Application Publication
(10) Pub. No.: US 2007/0222100 A1
(43) Pub. Date: Sep. 27, 2007

(54) Method and system using NIR spectroscopy for in-line monitoring and controlling content in continuous production of engineered wood products

(75) Inventors: Steve Husted, Baldwin, GA (US); Vinay Khanna, Atlanta, GA (US); Kenneth S. Chambers, Braselton, GA (US); Albert G. Landers, Dacula, GA (US)

Correspondence Address: Huber Engineered Woods L.L.C.;c/o J.M. Huber Corporation, Law Department, 333 Thornall Street, Edison, NJ, 08837-2220, US

(73) Assignee: Huber Engineered Woods L.L.C., Charlotte, NC (US)

(21) Appl. No.: 11/384,417

(22) Filed: Mar. 21, 2006

(51) Int. Cl. B27N 3/08

(52) U.S. Cl. 264/109; 264/113; 264/408; 425/174.4; 430/495.1; 425/150; 700/198

(57) ABSTRACT

Method and system using near infrared (NIR) spectroscopy for dynamically monitoring and controlling the proportion of resin solids or other additive solids in combination with other ingredients used in continuous production of resin-wood composite articles.

### FIELD OF THE INVENTION

The invention relates to a method and system using near infrared (NIR) spectroscopy for dynamically monitoring and controlling content in continuous production of engineered wood products, and particularly resin solids content and/or moisture content, as part of a continuous production line for making resin-wood composite articles.

### BACKGROUND OF THE INVENTION

Resin-wood composites, such as oriented strand board (“OSB”), wafer board, chipboard, fiberboard, etc., are widely used as construction materials, such as for flooring, sheathing, walls, roofing, concrete forming, and so forth. The wood component typically is virgin or reclaimed ligno-cellulosic material, which may be derived from naturally occurring hard or soft woods, singularly or mixed. Typically, the raw wood starting materials are cut into strands, wafers, chips, particles, or other discrete pieces of desired size and shape. These ligno-cellulosic wood materials can be “green” (e.g., having a moisture content of 5-30% by weight) or dried (e.g., having a moisture content of about 2-10 wt %).

In the commercial fabrication of OSB, for instance, multiple layers of raw wood “flakes” or “strands” are bonded together by a resin binder. For instance, in an oriented strand board, a binder resin is used to bond together adjacent strands. The binder resin typically contains curable polymer-forming chemical components, such as phenol-formaldehydes and/or isocyanates. The flakes or strands used in OSB production have been made by cutting logs into thin slices with a knife edge parallel to the length of a debarked log. The cut slices are broken into narrow strands generally having lengthwise dimensions which are larger than the widths, where the lengths are typically oriented parallel to the wood grain. The flakes are typically 0.01 to 0.05 inches thick, although thinner and thicker flakes can be used in some applications, and are typically, less than one inch to several inches long and less than one inch to a few inches wide. The raw flakes then may be dried. The raw flakes or other ligno-cellulosic wood materials are coated with a polymeric thermosetting binder resin and a sizing agent such as wax, such that the wax and resin effectively coat the wood materials. Conventionally, the binder, wax and any other additives are applied to the wood materials by various spraying techniques. One such technique is to spray the wax, resin and additives upon the wood strands as the strands are combined in a blender, such via tumbling in a drum blender. Binder resin and various additives applied to the wood materials are referred to herein as a coating, even though the binder and additives may be in the form of small particles, such as atomized particles or solid particles, which may not form a continuous coating upon the wood material.

The binder-coated flakes may then be spread on a conveyor belt to provide a first surface ply or layer having flakes oriented generally in line with the conveyor belt, then one or more plies that will form an interior ply or plies of the finished board is (are) deposited on the first ply such that the one or more plies is (are) oriented generally perpendicular to the conveyor belt. Then, another surface ply having flakes oriented generally in line with the conveyor belt is deposited over the intervening one or more plies having flakes oriented generally perpendicular to the conveyor belt. Plies built-up in this manner have flakes oriented generally perpendicular to a neighboring ply insofar as each surface ply and the adjoining interior ply. The layers of oriented “strands” or “flakes” are finally exposed to heat and pressure to bond the strands and binder together. The resulting product is then cut to size and shipped. Typically, the resin and sizing agent comprise less than 10% by weight of the oriented strand board.

Board product uniformity and quality is sensitive to formulation variations. Often, panel components are not measured directly but inferred from application rates. This situation has led to a gap in information about blending efficiency, which limits the ability to improve the process. There is a need for in-line rapid, noninvasive analysis methods for wood composite products. Direct measurement of the amount of adhesive, wax, moisture, or other binder constituents or additives applied to ligno-cellulosic particles, e.g., OSB flakes, has been a time-consuming procedure. This has been accomplished in the past, for example, by elemental analysis or image analysis. While off-line elemental analysis can give accurate measurements on the elements present in samples, a week or more may be required before results are returned from an outside lab. Delayed acquisition of analysis results may limit their usefulness for near-time adjustment of current process parameters such that considerable production may occur before a formulation variation from target conditions is identified. Elemental analysis is also of limited use for discriminating between and determining the concentrations of components whose elemental makeup contains significant carbon, hydrogen, and/or oxygen, since these are also the elements predominant in wood, and the test results do not differentiate between different sources of these elements. Waxes and polyols are two common OSB components that fall into this category. Other methods of wax analysis are in use, but they involve lengthy organic solvent extraction procedures.

Image analysis also has been used to analyze content of OSB composite wood products. Image analysis involves off-line photographing or scanning individual flakes, or paper onto which resin has been transferred, and using a computer to analyze the digital image. The coverage area of a colored material on a lighter-colored background, such as phenol-formaldehyde resin on a flake, is then calculated. This approach works well for colored components, such as phenol-formaldehyde resin, but not for colorless or light colored components such as isocyanate resins, urea-formaldehyde resins, polyols, or waxes. A dye may be added to the component or sprayed on the treated flake.

Spectroscopic techniques also have been described for monitoring ligno-cellulosic board formulations. All organic materials absorb infrared (including near-infrared) light according to Beer's law. Three categories of infrared spectroscopies are commonly recognized, classified by the energy of the light used, comprising: mid-infrared spectroscopy from 2400-25,000 nm, near-infrared (NIR) spectroscopy from 800-2400 nm, and far-infrared spectroscopy from 20,000-66,000 nm. Far IR is typically used for inorganic materials. Quantitative mid-IR analysis can be problematic due to baseline effects and the absorbance of background gases such as water vapor and carbon dioxide. NIR spectroscopy does not suffer from these difficulties, and it is generally faster and requires less sample preparation than mid-IR. NIR instruments are faster than mid-IR instruments because the energy from the lamp is more intense, the detector is more sensitive, and the Beer's law constant is greater in the NIR region.

NIR spectroscopic analysis of adhesive-treated wood flakes is time-dependent, because the adhesives undergo chemical reactions such as polymerization, even at room temperature. These changes in the chemical makeup of the samples result in changes in their spectra, which can make the spectra unsuitable for component concentration predictions which are related to calibrations based on samples that may have been handled differently after sampling. Conducting rapid spectra acquisition on freshly mixed and collected samples could reduce this variable.

NIR technology has been used in the wood industry, most commonly for moisture measurements. However, it may also be used for resin and wax analysis. U.S. Pat. Nos. 6,846,446 and 6,846,447 describe measuring resin content on resin-loaded wood materials using near-infrared (NIR) spectroscopy and a method for calibrating the instruments. The '446 and '447 patents describe measuring resin alone, and towards that object also describe removal of data and information about moisture content (and other non-resin components) of the samples before spectral data are analyzed for resin content.

There is a need for in-line noninvasive analysis methods for continuous resin-wood composite production that can dynamically support process control in real time and in a more versatile manner can detect and provide earlier process control interventions relative to various resin-wood composite additives when feed additive properties stray from targets or preselected specifications during a production run.

As will become apparent from the descriptions that follow, the invention addresses these needs as well as providing other advantages and benefits.

### SUMMARY OF THE INVENTION

This invention relates to a method and system using near infrared (NIR) spectroscopy for in-line monitoring of the component concentrations in additive feed streams for controlling solids-loading and/or moisture levels as part of a continuous resin-wood composite production line. It particularly relates to a method and system using near infrared (NIR) spectroscopy for dynamic in-line monitoring of resin solids in a resin composition feed stream and controlling of resin-loading by appropriately adjusting the blending proportions of resin solids and wood pieces as part of a continuous resin-wood production line, such as oriented strand board production. It also particularly relates to monitoring and controlling moisture content in such applications.

For purposes herein, “solids” or solids content” generally refers to non-aqueous content of a particular additive, or the aggregate or overall non-aqueous (non-moisture) content of a combined feed stream composition. Defined as such, the “solids” do not include water content, but can cover organic and/or inorganic compounds meeting the given definition. With respect to resin solids, they generally are constituted by the curable (poly)mer components (e.g., monomers, oligomers, polymers, and/or co-polymers) present in the additive.

Resin solids have a significant affect on the overall bonding performance of a binder resin composition, and thus on the integrity and structural performance of the oriented strand board or other resin-wood composite member product. The quality of the resin-wood composite trends to be particularly sensitive to the relative proportions of the resin solids and wood combined to form the composite. Other additive solids levels, e.g., wax solids, fire retardant solids, etc., also can have significant impact on one or more properties of the finished resin-wood composite product. The amount of moisture present in the wood and resin blend also can significantly impact properties of the finished resin-wood composite product. Generally, the moisture acts a “contaminant” which adversely impacts finished board quality.

In one embodiment, the present invention provides an in-line, noninvasive NIR spectroscopic-based method and system for resin-wood composite production that can provide for measurement of the solids concentration of one or more raw material feed stocks being used in the resin-wood composite production on an intermittent or continuous basis during a production run, such that earlier and rapid process control interventions are made relative to various resin-wood composite additives when a feed additive property, such as resin solids concentration, departs from a target during a production run. Consequently, dynamic adjustments in feed conditions may be implemented for maintaining proper blending and additive balances during a given production period or run.

In one particular embodiment, an in-line spectroscopic method is provided for monitoring resin solids concentration in a resin composition feed stream and controlling resin-loading, i.e., the blending proportions of resin solids and wood pieces, during continuous production of oriented strand board (OSB). The OSB is manufactured in the form of multiple stacked layers comprising at least a resin composition, wood strands, wax, and moisture. A calibration is generated with reference to training sample spectral data sets for NIR spectroscopic instrumentation for quantitatively correlating spectral results with respect to solid concentrations in resin compositions to be used in an oriented strand board production run. A resin composition feed stream comprising a quantitatively unknown amount of solids is irradiated with NIR radiation using the NIR spectroscopic instrumentation in-line and prior to blending of the wood strands, the resin composition, wax and moisture. The irradiation step involves exposing the resin composition feed stream to unfiltered NIR radiation at a succession of different wavelength values spanning a selected NIR spectral range of wavelengths, such as between about 1200 nm to about 2400 nm. Using the calibration and the resin composition feed stream data, a solids concentration value of the resin composition feed stream can be predicted. The predicted resin composition solids concentration is compared with a pre-selected target value. Adjustments are made with respect to at one least process variable effective to compensate for any difference determined between the predicted and target resin composition solid concentration values when compared in order to aid in maintaining a uniform proportion of resin solids to the wood strands. The in-line NIR-irradiation of a feed stock, prediction of solids content, comparison to target, and process variable adjustment steps are repeated intermittently during at least a portion of a given oriented strand board production run. The adjusted process variable may be selected from resin composition application rate (and thusly the resin solids application rate) to wood strands in a blender, wax application rate to wood strands in the blender, wood strand feed rate for resin-loading in the blender, or water blending rate with resin to be added to wood strands in the blender, etc. One or more of these process variables may be controlled as part of a control loop in which a controller analyzes predicted solids content values acquired on a feed additive via the in-line NIR-spectroscopic system and makes an appropriate process control adjustment upstream and/or downstream from the NIR-spectroscopic sampling situs to compensate for any departures from target values. Concurrent with any feed rate adjustments being applied, the resin composition, wax, wood strands, and moisture are blended to provide a resin-wood composite composition. Thereafter, a stack is formed comprising multiple layers of resin-wood composite composition wherein at least two of the stacked layers have strands generally oriented in differing angles relative to a machine direction of the process. The stack is hot pressed to form a unitary composite member.

In another particular embodiment, during continuous line operations, suitably calibrated NIR spectroscopic instrumentation is used to monitor resin solids concentration of a liquid phenol formaldehyde and/or isocyanate resin composition feed stream prior to its combination with wood pieces in a blender (i.e., a wood/resin-loading station). This enables more efficient and early adjustments (i.e., increases or reductions), if needed, to be implemented in the metering rate of the resin composition bearing the resin solids which are applied to the strands in the blender and/or the movement or feed rate of the wood to the blender, in order to effect an appropriate adjustment of the resin solids and wood proportions in the blender towards a target value. In this manner, a uniform desired resin/wood ratio (wt:wt) can be effectively maintained in the pre-press resin-wood composite mixtures and ultimate pressed composite products as part of an in-line assembly of oriented strand plies or another resin-wood composite ply or mass.

In another embodiment, the ratio of resin solids to curing accelerant solids (or other polymerization aid or other additive type) of a resin-based composition being fed to a wood and resin blender can be monitored and controlled with the inventive method and system. For example, NIR spectra acquired on “unknown” process streams during actual production can have their resin solids and accelerant contents simultaneously predicted from respective pre-established calibration curves used in the process control algorithm for these components, and then introduction rates of one or both ingredients can be appropriately manipulated via the control system, if necessary, to maintain the resin solids content:accelerant content ratio in the resin feed composition stream being fed to the wood and resin blender at a target value that has been pre-established therefor.

In yet another embodiment, the amount of water that may be present as a potential contaminant in a feed stream being fed to a wood and resin blender also can be can be monitored and controlled as part of the inventive method and system.

The present invention is generally applicable for providing process control relative to any solid-containing additive used in continuous production of resin-wood composite products. The present invention also is generally applicable to the manufacture of resin-ligno-cellulosic composite board products. This invention is particularly applicable to the manufacture of multi-layered board materials in which the constituent layers or plies are composites of small wood pieces, such as wood strands, flakes, chips, wafers, slivers, or particles, or the like, which are bound together with a binder resin. This invention is especially applicable to the manufacture of oriented strand board (OSB), but it is not limited thereto, as multi-layered wafer boards, flake boards, particle boards, and the like, are also encompassed by the invention. The multi-layered boards manufactured by the method and system of this invention can be used advantageously as a general construction material for exposed or covered flooring, concrete formers, sheathing, walls, roofing, cabinet work, furniture, and so forth.

### BRIEF DESCRIPTION OF THE DRAWINGS

FIG. 1 is a flow chart of a continuous oriented strand board production line including a system for dynamically monitoring resin solids concentrations in a resin composition feed stream and controlling the amount (rate) of resin solids being applied to wood strands at a resin/wood blender effective to maintain uniform resin-loading according to an embodiment of the invention.

FIG. 2 is a block diagram of a method for monitoring resin solids concentrations of a resin feed stock stream using in-line NIR spectroscopy and dynamically controlling resin-loading in an OSB production line according to an embodiment of the invention.

FIG. 3 is a more detailed flow chart of a method for calibrating and quantitatively analyzing solid concentrations of a resin feed stock stream prior to its introduction to a resin/wood blender of an OSB production line using NIR spectroscopy according to an embodiment of the invention.

### DETAILED DESCRIPTION OF THE PREFERRED EMBODIMENTS

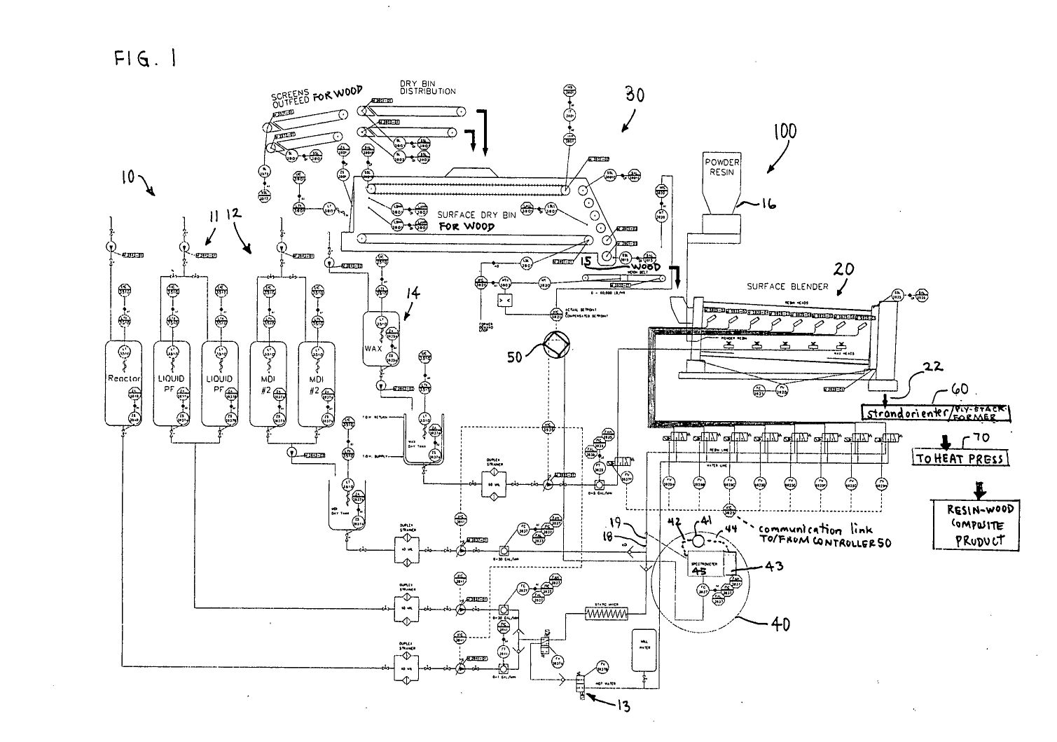

Referring to FIG. 1, an exemplary non-limiting system 100 for production of orient strand board (OSB) according to embodiments of the present invention is illustrated. In this illustration, different types of liquid resins 11 and 12 drawn from resin supply station 10, moisture 13, wax 14, and wood strands 15 are independently fed to surface blender 20 which serves as a resin-loading station for this production layout. These various feed streams each have associated respective flow control mechanisms for fluid feeds or rate-controlled conveyance mechanisms for the wood feed, as applicable, suitable for being controlled to make desired changes in a respective feed stream's feed rate into the resin-wood blender 20. It will be appreciated that the above-indicated ingredients are merely illustrative and non-exhaustive.

Wood-strand material 15 is accumulated and directed from the wood strand sorting/distribution/conveying assemblage 30 for entry into and for controlled in-line movement through resin-loading station 20. Powdered phenolic or other curable powdered resin 16 also may be separately introduced to blender 20 as shown. Unlike the liquid resin sources its solids content is presumed to remain constant for purposes of this invention. The liquid form resins 11 and 12 are capable of being atomized, which usually makes them desirable as the primary or sole resins used. They generally comprise resin solids dispersed in a liquid carrier, which typically is a volatile material or solvent. The moisture source 13 can combined in controlled amounts with the liquid form resins 11 and 12 in forming the resin composition fed into blender 20 before and/or after NIR spectroscopic instrumentation station 40. In a particular embodiment, resin-loading for continuous in-line OSB assembly is carried out during passage of the wood 15 through fluidized-bed resin-loading station 20 where the resin composition and wax is introduced. The resin-loaded wood strands 22 are discharged from the resin-loading station 20 and conveyed to continuous strand orienting/ply-stack forming assemblage 60 that precede a hot pressing station(s) 70, and these particular process stations may be generally conventional in nature. The resin-wood composite products obtained may be cut to size, edge-grooved, sanded, etc., in conventional manners. It also will be appreciated that the system 100 may comprise more than one surface blender. For instance, surface layers of resin-wood composites may be formulated with a different combination of additives as compared to a core layer thereof. If so, different surface blenders may be arranged in parallel in the system 100 to allow different resin compositions to be applied to different streams of wood strands before the respective resulting resin-wood blends are arranged into a composite stack.

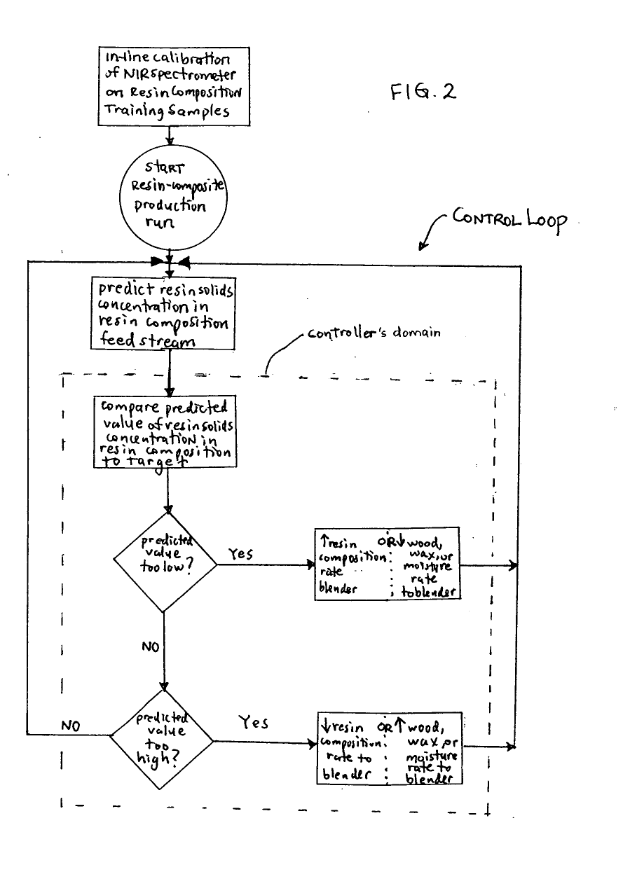

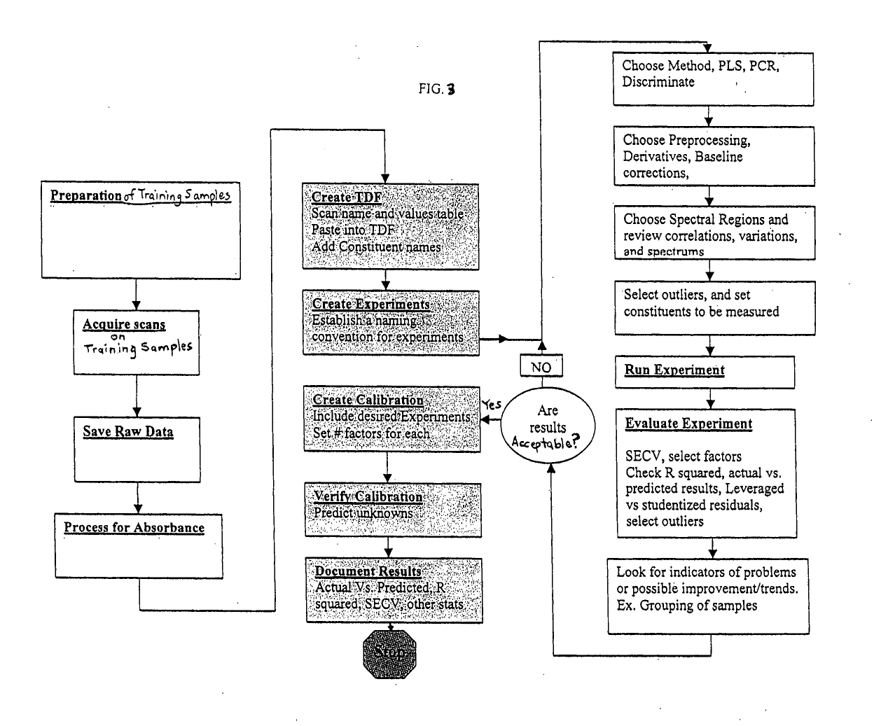

As indicated in FIG. 1, in-line calibration of the resins solids concentration of the combined resin composition feed stream 18 with NIR-spectroscopic measurements are made at on-line station 40 located upstream from resin-loading station 20, as shown in FIG. 1. The calibration and prediction methodology applied for monitoring resin solids or other additive solids content in resin composition feed stream 18 is explained in greater detail below in connection with the discussions of FIGS. 2-3.

Referring still to FIG. 1, in order to support in-line NIR spectroscopic measurements on the resin composition at station 40, a probe 41 may be inserted directly into the resin composition stream 18 as it flows through pipeline 19 at a point before the resin composition enters resin-loading station 20. Suitable in-line probes in this regard are described, e.g., in U.S. Pat. No. 6,300,633 B1, which descriptions are incorporated herein by reference. As described therein, and applicable here, a sample cell can be positioned on probe 41 positioned between two opposite NIR windows, wherein one optical fiber 42 connects probe 41 with a remote NIR source 43, while another optical fiber 44 connects probe 41 with a remote spectrometer 45. The spectrometer and NIR light source may be housed or bundled within the same instrumentation. Light passes through the resin composition 18 as it flows between the NIR windows of the sample cell of the probe 41 to the spectrometer 45. The spectra generated by spectrometer 45 are then relayed to a controller system 50 or other computer system. The spectrometer 45 may be programmed to take measurements at regular intervals or continuously. Alternatively, communication link may permit command signals from controller 50 to dictate when and at what interval the density measurements are taken by the densitometer. The controller 50 or other computer system includes software appropriate for analyzing the data collected by the spectrometer and applying an appropriate chemometric model thereto. It also is capable of correlating measured/predicted resin solid concentrations acquired in-line during an OSB production run with appropriate dynamic process control adjustments that may be needed and applied on the blender's feed streams.

Any of the known and commercially available NIR probes which is capable of functioning at the temperatures and pressures present in the resin composition pipeline may be used. A specific example of a suitable commercially available probe is the Series 5000 Near Infrared Photometer with a 15-30 p.s.i.g., 10 cc/minute purity of nitrogen path length which is available from Teledyne Analytical Instruments. Any optical fiber or cable which is capable of relaying the NIR beam from the NIR source to the probe without absorbing any significant amount of the optical energy in the beam may be used in the practice of the present invention. Suitable optical fibers or cables are described, for example, in U.S. Pat. No. 6,300,633 B1.

The beam of light used to generate the NIR spectra is transmitted from an NIR source capable of emitting light at wavelengths of from about 1000 nm to about 2100 nm, particularly about 1200 nm to 2400 nm. The spectrometer measures the absorption spectrum of the process stream. Any of the commercially available near infrared (“NIR”) spectrometers may be used in the practice of the present invention. A NIR source with a strong emission in the 1000 to 2100 nm range, particularly about 1200 nm to 2400 nm, may be used to practice the method of the present invention. A specific example of a suitable commercially available combined spectrometer/NIR source instrument is indicated below.

Referring to FIG. 2, a general block diagram is shown for calibrating and quantitatively analyzing resin solids concentrations of the resin composition feed stream and controlling resin-loading at the resin/wood blender station in production of resin-wood composites using NIR spectroscopy according to an embodiment of the invention. For purposes herein, “calibration” refers to model development in which a series of representative samples are analyzed spectrally and the resultant data evaluated statistically. Once a valid set of spectral data exists, it serves as a predictive data set for future determinations for compositions of unknown samples. The predictive sample set includes examples of historically observed variation in the manufacturing process. For predictable quantitation, the initial sample set includes compositions comprised of ingredients in respective known concentrations. The statistics applied to the chemical and spectral properties for analytical purposes are referred to herein as “chemometrics.” Calibration equations are generated which relate component absorbance with predicted concentration of each of multiple components constituting unknown resin-wood composite compositions.

In this embodiment, sample analysis by NIR spectroscopy is performed under three principal steps. After calibration of the instrument with spectra of samples whose composition is known (i.e., “training samples’), the spectra of unknown samples measured in-line during a production run can be compared to the calibration samples to determine the component concentrations. The calibration should be conducted on resin compositions containing the same components as those expected to be used during actual continuous OSB production, and under flow, temperature and pressure conditions in pipeline 19 that are similar to that expected during actual OSB production conditions. The calibration and comparisons are performed by chemometric analysis, a statistical method for analyzing spectral data, of the spectral data. Software packages for chemometric analysis are commercially available which may be adapted to perform this step. This type of calibration differs from traditional quantitative spectral methods in that the absorbance across the entire NIR spectrum range can be used in the analysis, rather than at a single or only several wavelengths.

Unlike prior procedures involving the use of NIR spectroscopy to measure resin content in engineered wood products which also remove absorptive effects of water prior to analyzing the NIR spectra, the inventive methods make it possible to measure the resin solids content, or another additive solids content, of the resin composition without making unusual modifications to the spectral data. Upstream quantitative measurement of resin solids content in the resin composition is critical as the bonding quality achieved in the pressed composite product is a direct function of concentration of resin solids in the resin-wood premixtures prepared in the blender and subsequently advanced to the pressing operation.

FIG. 3 shows a more detailed flow chart for implementing the calibration and prediction steps of the inventive method, and its features will be better understood from the detailed discussions below. For example, in one exemplary implementation of the inventive method, the basic steps include: 1) determine goals and identifying key model parameters; 2) create a training set of resin compositions of known resin solids concentrations; 3) create a training data file; 4) set up experiments for testing calibration models; 5) run experiments using the diagnostic models; 6) examine model diagnostics and statistics; 7) modify and re-run experiments; 8) build a calibration; 9) predict resin solids content of unknown samples of resin compositions. In the present invention, automated prediction on unknown samples can be provided intermittently or continuously by in-line measurements taken at the spectroscopic instrumentation station 40 during a production run.

Information about each and every component of a sample is contained in its NIR spectrum, in addition to resin solids information. When building a calibration, the software measures changes in these spectra relative to the others in the training set. The software algorithms then generate a calibration model by iterative processes in which the values of error functions are reduced. The result is a model or models in which spectral changes correlate with the changes in each component or property which is desired to be measured, based on the component or property levels provided as input. As long as multiple components or properties do not vary in a collinear fashion, the calibration models are specific for particular components or properties. Theoretically, a calibration can be built for any measured component or property of the sample, given a properly constructed training data set. However, it is up to the user to evaluate the quality of the given model, based on factors such as error functions, statistical tests, and outliers, and decide whether it is acceptable for use.

In practicing the present invention, resin compositions for wood composite blends may be prepared which can be conventional in nature for that application, which combine ingredients including a source of resin solids, moisture, and optionally one or more other additives such as polyols and/or other cure accelerators, chain extenders, or catalysts; fire retardants; wax; etc., in which each component has a concentration during processing which is expected to fall within a predetermined operating range for that component. Process control is provided for determining the specific concentration of an additive within its pre-established operating range before the wood surface blender station during a production run so that adjustments may be dynamically made if necessary to the additive feed rate. Also, the ratio of resin solids to curing accelerant solids, e.g., polyols, etc., of a resin-based composition being fed to a wood and resin blender also can be monitored and controlled with the inventive method and system. Additionally, the amount of non-solid ingredients, such as water or other potential contaminant, which may be present in the feed stream being fed to a wood and resin blender can be can be monitored as part of the inventive method and system.

The near-infrared instrumentation used in these calibration runs and for in-line production measurements/predictions may be a Teledyne Model 5000 photometer. Other commercial near-infrared analyzers and user interface software also could be adapted and used to obtain similar results. Each spectrum collected is an average of multiple, e.g., about 20-25, particularly about 25, single-scan spectra, but a different number of scans may be averaged to obtain similar results.

The near-IR spectra of the known samples are treated by a chemometric analysis software package to create a calibration for each component of interest. The main steps of this procedure involved providing the concentrations of each component (based on oven-dry wood weight) of interest for the spectrum of each sample and selecting options for data treatment. Commercial chemometric software packages may be adapted and used for this purpose, such as Infomertix Pirouette Version 3.11 chemometric modeling software or ThermoGalactic's PLS plus/IQ. As generally known, PLS uses the constituent values during the principal component decomposition to “weight” the calibration spectra. The result is a series of calibration equations; one for each PLS principal component, where the principal components are directly related to the constituents of interest. Commercial chemometric software packages are available which permit the operator to select the calibration type and number of model factors. The software calibration types may be selected from, e.g., PLS-1, PLS-2, PCR, PCA, and discriminate. PLS-1 is preferred. It is important to use enough factors to adequately model the data and avoid underfitting, but not too many that could lead to poorer predictions of unknowns.

The diagnostic type also may be selected from the software. It is employed to validate the calibration equations, but cross-validation is preferred. Cross validation attempts to emulate predicting “unknown” samples by using the training set data itself. One or more samples are left out during the calculation, then predicted back with the model. This process is repeated until all samples have been left out. This validation approach provides better accuracy in prediction of true unknowns and better outlier prediction. Limited data preparation may be applied, such as “mean center” options provided in some commercial chemometric software. However, data preprocessing algorithms generally need not be applied to remove interferences in data in terms of path length corrections, baseline corrections and statistical corrections, for the wood-resin chemistries of interest. Desired spectral region selections and settings and exclusion of outliers can be performed in commercial chemometric software via graphical user-interface. Removal of outliers, i.e. samples within the training set which do not fit, usually improves the predictive ability of the developed model and avoids introduction of bias in the model. Outliers often arise from errors when creating the training set (e.g., transcription error, spectrometer error, etc). Many commercial chemometric modeling software programs include statistical tools, e.g., Mahalanobis distance, F-ratio and F-statistic, to assist a user in identifying outliers. The training set also should be examined for collinearity. Plots of two different constituents are collinear if the concentration for one constituent is a linear function of the concentration of another. If a training set is collinear, unknowns may not be predicted properly.

To quantitatively analyze unknown resin composition samples using the validated calibration equations, samples of unknown resin compositions are probed at NIR-spectroscopic instrumentation station 40. A routine within the chemometric software compares spectra of unknown samples to the calibration set and predicts the resin solids concentrations of the resin composition feed stream 18 of the samples. Statistical measures of the similarity of the unknown spectrum to the calibration set indicate how well each spectrum matches the data in the calibration set, and by extension how reliable was the prediction.

As indicated in the block diagram of FIG. 2, if predicted/measured resins solids concentrations differ from a pre-selected target value, then compensatory adjustments are made via a process control loop to one or more feed streams upstream or at blender 20 to trend the resin/wood blending proportions in the blender 20 back towards a desired value. These comparisons of measured and target values, and process control adjustments are conducted by controller 50. When the resin solids concentration is measured for the resin composition feed stream 18, it can be mathematically correlated with an expected resulting blending proportion with wood 15 at the blender 20 for the current respective introduction rates thereto. To the extent the measured resins solids in feed stream 18 depart from a target, the controller 50 can automatically make an appropriate offsetting adjustment in the feed rate of one more of the ingredients being fed to blender 20. In one embodiment, the controller 50 embodies an algorithm which inter-relates, in mathematical terms, the magnitude and +/−character of an offset of a measured resin solids concentration with the target, with introduction flow rate of one or more of the resin composition, wax, moisture and/or the wood feed rate to the blender 20.

As indicated in FIG. 2, and by way of example, if the measured resins solids value is too low, offsetting process variable adjustments available include increasing the resin composition feed rate to the blender 20, which implicitly increases the resin solids levels being introduced thereto. The rate of resin composition introduction at blender 20 can be adjusted through valved control located at blender 20. Some changes further upstream in other valved controls on the resin streams nearer their supply vessels also can commanded by controller 50 to support this remedial action. Alternatively, the wood 15 conveyance/introduction rate into blender 20 can be decreased, and/or the wax or moisture feed streams can be decreased to provide a relative increase in the proportion of resin solids at the blender. To the extent VOC content of the resin composition will be largely eliminated during OSB production, the making of offsetting adjustments to that ingredient are not particularly useful.

As also indicated in FIG. 2, if the measured resins solids value is too high, offsetting process variable adjustments available include decreasing the resin composition feed rate to the blender 20, which implicitly decreases the resin solids levels being introduced thereto. Alternatively, the wood 15 conveyance/introduction rate into blender 20 can be increased, and/or the wax or moisture feed streams can be increased to provide a relative decrease in the proportion of resin solids at the blender. The above-mentioned process variable adjustment options are exemplary and not limited. They also can be implemented singly or in complementary combinations to offset detected departures in resin solids content of resin composition 18 from target. These process variable adjustments preferably are implemented under automated control of controller 50. However, it also is feasible that offsetting manual changes could be made by an operator to one or more feed stream introduction rates at blender 20 in response to resin solids concentrations acquired and measured at NIR-spectroscopic instrumentation station 40 and then displayed for an operator in some manner. Also, the ratio of resin solids to curing accelerant solids (or other polymerization aid or other additive type) of a resin-based composition being fed to a wood and resin blender can be monitored and controlled with the inventive method and system. For example, NIR spectra acquired on “unknown” process streams during actual production can have their resin solids and accelerant contents simultaneously predicted from respective pre-established calibration curves used in the process control algorithm for these components, and then introduction rates of one or both ingredients can be appropriately manipulated via the control system, if necessary, to maintain the resin solids content:accelerant content ratio in the resin feed composition stream being fed to the wood and resin blender at a target value that has been pre-established therefor.

Additionally, the amount of water that may be present as a potential contaminant in a feed stream being fed to a wood and resin blender also can be can be monitored and controlled as part of the inventive method and system. In this alternate embodiment, a calibration curve also may be developed from NIR spectra for moisture content of the feed resin composition. Then, NIR spectra acquired on “unknown” process streams during actual production can have their moisture content predicted from the pre-established calibration curve and algorithm for this component. Process streams which introduce moisture can be adjusted accordingly via the control system. In this manner, moisture levels also may be directly monitored and controlled during a resin-wood composite production run in addition to or in lieu of direct solids level control.

The controller 50 may be programmed to operate in an automated dynamic manner without needing manual inputs. The controller 50 also may communicate with a computer graphical user interface which displays and outputs measured resin solids values and process variable adjustments being implemented and permits an operator to input process targets and process control adjustment preferences. Default process variable adjustment actions can be preprogrammed into the controller system. For example, the wood feed rate to the blender 20 may be pre-selected as the process variable to be adjusted if resin solids concentrations measured in-line at NIR spectroscopic instrumentation station 40 during a continuous production run depart from target. As can be appreciated, the system 100 can utilize controller 50 as part of feed forward and feedback process control functionalities.

In one non-limiting implementation, the controller 50 may provide proportional-integral-derivative (PID) control using the analyzed output of the spectrometer 45 to directly control the wood feed rate to blender 20. The controller 50 can be used to automatically adjust the wood feed rate to the blender 20, as the controlled process variable, to hold and maintain a resin solids/wood wt:wt ratio in blender 20 at a predetermined target. The offset parameter of this control loop is the difference between the resin solids set-point value or target and a real-time measurement of that process variable taken on-line at station 40. Tolerances may be programmed into the treatment of the offset. That is, differences calculated between the target and actual resins solids concentrations may be numerically cut off at a selected significant figure such that smaller numerical deviations or offsets from the selected target value are effectively ignored, and no remedial action is taken on a process variable until deviations are observed which are within the range of significant figures being applied.

The controller system may comprise a programmable logic controller (PLC) having access to computer code, embodied in microelectronic hardware mounted on a motherboard or the like and/or in software loaded on a remote computer in communication therewith. PLC modules having these general functionalities are commercially available which can be adapted to implement the concepts described herein. A non-limiting example of a controller system developed and adapted for implementing this invention which has both the hardware and software necessary to implement such process control as described herein is a Teledyne Analytical Instruments Series 5000 Near Infrared Photometer with signal and output ranges 01 VDC and 4-20 maDC, configured in communication with process control components including a PLC (programmable logic controller), such as implemented using a Allen-Bradley ControlLogix system and associated RSLogix5000™ software, interfaced with Wonderware ActiveFactory® trending, analysis and reporting software. The various control software is loaded on a computer or computers in communication with the photometer and various additive feed rate control components. The process control software includes code adapted to provide an algorithm which inter-relates, in mathematical terms, the predicted value of additive solids derived from real-time measurement with a target value, and generates a process control adjustment calculated to address (reduce or eliminate) any identified discrepancy. The photometer may communicate with the PLC via a communication wire, an Ethernet cable, or a wireless communication system (e.g., via radio frequency communications), or by other suitable means. Wonderware ActiveFactory® is a data acquisition system which provides historical data that is then used to develop modeling whereas collected data can be assembled to look at variation in input and output variables.

The resin-wood composite products that can be manufactured using the NIR spectroscopic-based method and system of the present invention are not particularly limited. For instance, resin-wood ligno-cellulosic composites include composite materials such as oriented strand board, wafer board, chipboard, fiberboard, etc. Ligno-cellulosic materials may be derived from naturally occurring hard or soft woods, singularly or mixed, whether such wood is green or dried. Typically, the raw wood starting materials, either virgin or reclaimed, are cut into strands, wafers or particles of desired size and shape. These ligno-cellulosic wood materials can be “green” (e.g., having a moisture content of 5-30% by weight) or dried, wherein the dried materials have a moisture content of about 2-18 wt %. Preferably, the ligno-cellulosic wood materials comprise dry wood parts having a moisture content of about 3 to 14 wt %. The wood materials are typically 0.01 to 0.5 inches thick, although thinner and thicker wood materials can be used in some applications. Moreover, these wood materials are typically less than one inch to several inches long and less than one inch to a few inches wide.

In commercial manufacture of oriented strand board (OSB) panels, e.g., ligno-cellulosic wood materials are coated with a curable polymeric thermosetting binder resin and wax additive, such that the wax and resin effectively coat the wood materials. The resin component that may be used in these mixtures include, but are not limited to, phenol-formaldehyde resin (powdered or liquid), methylene diamine isocyanate (MDI), melamine-formaldehyde resin, melamine-urea-formaldehyde resin, melamine-urea-phenol-formaldehyde resin, soy-protein based resins, and combinations thereof. Preferred binders include 4,4-diphenyl-methane diisocyanate (MDI) and phenol formaldehyde (powder or liquid). The binder loading level is preferably in the range of 1-10 wt %, based upon the oven-dried wood weight, more preferably 2-5 wt %.

Other conventionally used additives, such as waxes, polyols, inorganic or organic curing accelerators, fire retardants, recycled sanding dust, fillers, etc. A wax additive is commonly employed to enhance the resistance of the OSB panels to absorb moisture. Preferred waxes are slack wax or a micro-crystalline wax. The wax loading level is preferably in the range of 0.5-2.5 wt %, based upon the oven-dried wood weight.

Alumina trihydrate (ATH), also known as aluminum hydroxide, is commonly used as both a filler and a fire retardant in these synthetic polymeric materials and can be identified by the chemical formulae of Al(OH)₃ or Al₂O₃.3H₂O. As a result of its well-known fire retardant properties, the use of alumina trihydrate as a particle filler results in a highly flame resistant polymeric product.

Conventionally, the binder, wax, polyols, inorganic curing accelerators, fire retardants, etc., and any other additives are applied to the wood materials by various spraying techniques. One such technique is to spray the wax, resin and additives upon the wood strands as the strands are tumbled in a drum blender. These ingredients may be added via spray or otherwise into the drum blender so that at least a portion of the additives will coat the wood materials. The spray technique may be, for example, such as by use of electric atomizers, hydraulic or pneumatic sprayers, etc. Binder resin and various additives applied to the wood materials are referred to herein as a coating, even though the binder and additives may be in the form of small particles, such as atomized particles or solid particles, which may not form a continuous coating upon the wood material.

The blended mixture is formed into either a random mat or oriented multi-layered mats. In particular, the coated wood materials are spread on a conveyor belt in a series of alternating layers, where one layer will have the flakes oriented generally in line with the conveyor belt, and the succeeding layer oriented generally perpendicular to the belt, such that alternating layers have coated wood materials oriented in generally a perpendicular fashion. Subsequently, the formed mats are pressed under a hot press machine, which fuses and binds together the coated wood materials to form a consolidated OSB panels of various thickness and size. Preferably, the panels of the invention are pressed for 2-5 minutes at a temperature of about 325 to about 500 degrees Fahrenheit. The resulting composite panels may have a density in the range of about 38-50 pcf (ASTM D1037-98) and a thickness of about 0.25 inch to about 1.5 inch, depending on the composition and press conditions. The hot pressed panels may be cut to size, edge-grooved, sanded, printed, stacked, etc.

While the invention has been particularly described with specific reference to particular process and product embodiments, it will be appreciated that various alternations, modifications and adaptations may be based on the present disclosure, and are intended to be within the spirit and scope of the present invention as defined by the following claims.

What is claimed is:

1. An in-line spectroscopic method for monitoring and control of additive solid levels during continuous production of resin-wood composite material members comprising a resin composition, wood pieces, wax, and moisture, comprising:
(a) providing a plurality of training samples comprising a selected additive of a resin-wood composite material having quantitatively predetermined respective amounts of solids;
(b) irradiating said plurality of training samples with NIR radiation using NIR spectroscopic instrumentation including an associated source of NIR radiation, wherein said irradiating comprises exposing said training samples to NIR radiation at a succession of different wavelength values spanning a selected NIR spectral range of wavelengths;
(c) generating a calibration with reference to the training sample spectral data sets for the NIR spectroscopic instrumentation for quantitatively correlating spectral results with solid concentrations in the selected additive to be used in a resin-wood composite member production run;
(d) irradiating the feed stream of the selected additive comprising a quantitatively unknown amount of solids with NIR radiation using the NIR spectroscopic instrumentation in-line and prior to blending of the wood pieces, the resin composition, wax and moisture, wherein said irradiating comprises exposing said selected additive feed stream to unfiltered NIR radiation at a succession of different wavelength values spanning the selected NIR spectral range of wavelengths;
(e) predicting, using the calibration and the selected additive feed stream spectral data, a solid concentration of the selected additive feed stream;
(f) comparing the predicted selected additive solids concentration with a pre-selected target value;
(g) adjusting at one least process variable effective to compensate for any difference determined between the predicted and target selected additive solids concentration values when compared in step (f);
(h) blending resin composition, wax, wood pieces, and moisture in a blender, providing a resin-wood composite composition;
(i) hot-pressing the resin-wood composite composition effective to form a unitary resin-wood composite member; and
(j) repeating steps (d) to (g) intermittently during at least a portion of a given resin-wood composite material member production run.

2. The method of claim 1, wherein the resin composition includes at least one of liquid phenol formaldehyde resin and liquid isocyanate resin.

3. The method of claim 1, wherein the wood component comprises a wood material selected from the group consisting of wood strands, wood flakes, wood particles, sawdust, wood wafers, and wood fibers.

4. The method of claim 1, wherein the selected additive is the resin composition.

5. The method of claim 4, wherein the adjusted process variable comprises a resin composition application rate to wood pieces in the blender.

6. The method of claim 1, wherein said irradiating of the selected additive feed stream in step (d) comprises transmitting light through the selected additive stream with a probe inserted within a passageway through which the selected additive feed stream flows, at transmission wavelengths of from about 1200 nm to about 2400 nm, effective that NIR light absorption data is collected on the selected additive feed stream.

7. The method of claim 1, wherein the generating of a calibration with reference to the training sample spectral data sets for the NIR spectroscopic instrumentation further comprises quantitatively correlating spectral results with moisture concentrations, and the irradiating, predicting, comparing and adjusting steps are conducted with reference to a predicted moisture concentration and a pre-selected target value therefor.

8. An in-line spectroscopic method for monitoring and control of resin solids content during continuous production of oriented strand board including multiple stacked layers comprising a resin composition, wood strands, wax, and moisture, comprising:
(i) generating a calibration with reference to training sample spectral data sets for NIR spectroscopic instrumentation for quantitatively correlating spectral results with respect to solid concentrations in resin compositions to be used in an oriented strand board production run;
(ii) irradiating a resin composition feed stream comprising a quantitatively unknown amount of solids with NIR radiation using the NIR spectroscopic instrumentation in-line and prior to blending of the wood strands, the resin composition, wax and moisture, wherein said irradiating comprises exposing said resin composition feed stream to unfiltered NIR radiation at a succession of different wavelength values spanning a selected spectral range of wavelengths;
(iii) predicting, using the calibration and the resin composition feed stream data, a solid concentration of the resin composition feed stream;
(iv) comparing the predicted resin composition solids concentration with a pre-selected target value;
(v) adjusting at one least process variable selected from resin composition application rate to wood strands in a blender, wax application rate to wood strands in the blender, wood strand feed rate for resin-loading in the blender, or water blending rate with resin to be added to wood strands in the blender, effective to compensate for any difference determined between the predicted and target resin composition solids concentration values when compared in step (iv);
(vi) blending the resin composition, wax, wood strands, and moisture in the blender, providing a resin-wood composite composition;
(vii) forming a stack comprising multiple layers of resin-wood composite composition wherein at least two of the stacked layers have strands generally oriented in differing angles relative to a machine direction of the process;
(viii) hot pressing the stack effective to form a unitary composite member; and
(ix) repeating steps (ii) to (v) intermittently during at least a portion of the given oriented strand board production run.

9. The method of claim 8, wherein the resin composition includes at least one of liquid phenol formaldehyde resin and liquid isocyanate resin.

10. The method of claim 9, wherein the adjusted process variable comprises the resin composition application rate to the wood strands in the blender.

11. The method of claim 8, wherein said irradiating of the resin composition feed stream in step (ii) comprises transmitting light through the resin composition feed stream with a probe inserted therein at transmission wavelengths including from about 1200 nm to about 2400 nm effective that NIR light absorption data is collected on the resin composition feed stream.

12. An in-line spectroscopic method for monitoring and control of resin solids content during continuous production of oriented strand board including multiple stacked layers comprising a resin composition, wood strands, wax, and moisture, comprising:
(a) providing a plurality of training samples comprising a resin composition having quantitatively predetermined respective amounts of solids;
(b) irradiating said plurality of training samples with NIR radiation using NIR spectroscopic instrumentation including an associated source of NIR radiation, wherein said irradiating comprises exposing said training samples to NIR radiation at a succession of different wavelength values spanning a selected spectral range of wavelengths including a range of about 1200 nm to about 2400 nm;
(c) generating a calibration with reference to the training sample spectral data sets for the NIR spectroscopic instrumentation for quantitatively correlating spectral results with solid concentrations in resin compositions to be used in an oriented strand board production run;
(d) irradiating a resin composition feed stream comprising a quantitatively unknown amount of solids with NIR radiation using the NIR spectroscopic instrumentation in-line and prior to blending of the wood strands, the resin composition, wax and moisture, wherein said irradiating comprises exposing said resin composition feed stream to unfiltered NIR radiation at a succession of different wavelength values spanning a selected spectral range of wavelengths including a range of about 1200 nm to about 2400 nm;
(e) predicting, using the calibration and the resin composition feed stream data, a solid concentration of the resin composition feed stream;
(f) comparing the predicted resin composition solids concentration with a pre-selected target value;
(g) adjusting at one least process variable selected from resin composition application rate to wood strands in a blender, wax application rate to wood strands in the blender, wood strand feed rate for resin-loading in the blender, or water blending rate with resin to be added to wood strands in the blender, effective to compensate for any difference determined between the predicted and target resin composition solids concentration values when compared in step (f);
(h) blending the resin composition, wax, and wood strands in the blender, providing a resin-wood composite composition;
(i) forming a stack comprising multiple layers of resin-wood composite composition wherein at least two of the stacked layers have strands generally oriented in differing angles relative to a machine direction of the process;
(j) hot pressing the stack effective to form a unitary composite member; and
(k) repeating steps (d) to (g) intermittently during at least a portion of the given oriented strand board production run.

13. The method of claim 12, wherein the resin composition includes at least one of liquid phenol formaldehyde resin and liquid isocyanate resin.

14. The method of claim 12, wherein the adjusted process variable comprises the resin composition application rate to the wood strands in the blender.

15. The method of claim 12, wherein the adjusted process variable comprises the moisture introduction rate to the blender.

16. The method of claim 12, wherein the adjusted process variable comprises the wood strand feed rate to the blender.

17. The method of claim 12, wherein said irradiating of the resin composition feed stream in step (d) comprises transmitting light through the resin composition feed stream with a probe inserted therein at transmission wavelengths including from about 1200 nm to about 2400 nm effective that NIR light absorption data is collected on the resin composition feed stream.

18. The method of claim 12, wherein the amounts of solids of the training samples are randomly chosen for each training sample within a respective preselected range.

19. The method of claim 12, wherein the NIR spectroscopic instrumentation comprises a rapid-scanning grating system operable to use a diffraction grating to separate a polychromatic spectrum into constituent wavelengths.

20. The method of claim 12, wherein said generating of the calibration comprises applying multivariate data analysis to the training sample spectral data sets.

21. A system for in-line spectroscopic monitoring and control of resin solids content during continuous production of oriented strand board including multiple stacked layers comprising a resin composition, wood strands, wax, and moisture, comprising:
(A) calibration-generating software for generating a calibration with reference to training sample spectral data sets for NIR spectroscopic instrumentation for quantitatively correlating spectral results with respect to solid concentrations in resin compositions to be used in an oriented strand board production run;
(B) NIR spectroscopic instrumentation for irradiating a resin composition feed stream comprising a quantitatively unknown amount of solids with NIR radiation using the NIR spectroscopic instrumentation in-line and prior to blending the wood strands, the resin composition and the wax, wherein said irradiating comprises exposing said resin composition feed stream to unfiltered NIR radiation at a succession of different wavelength values spanning a selected spectral range of wavelengths;
(C) predicting software for predicting, using the calibration and the resin composition feed stream data, a solid concentration of the resin composition feed stream;
(D) comparing software for comparing the predicted resin composition solids concentration with a pre-selected target value and generating output signals indicative of the comparison results;
(E) a controller, adapted for communication with and acquisition of the output signals of the comparing software, operable to adjust at one least process variable selected from a resin composition application rate to wood strands in a blender, a wax application rate to wood strands in the blender, wood strand feed rate for resin-loading in the blender, or water blending rate with resin to be added to wood strands in the blender, effective to compensate for any difference determined between the predicted and target resin composition solids concentration values when compared in step (iv);
(F) blender for blending the resin composition, wax, and wood strands, providing a resin-wood composite composition;
(G) stack assembler equipment for forming a stack comprising multiple layers of resin-wood composite composition wherein at least two of the stacked layers have strands generally oriented in differing angles relative to a machine direction of the process;
(H) hot-press for hot pressing the stack effective to form a unitary composite member.
